(19) United States
(12) Patent Application Publication
(10) Pub. No.: US 2016/0194113 A1
(43) Pub. Date: Jul. 7, 2016

(54) Liquid Absorbing Cupholder

(71) Applicant: Lisa C. Aquino, Batavia, NY (US)

(72) Inventor: Lisa C. Aquino, Batavia, NY (US)

(21) Appl. No.: 14/872,667

(22) Filed: Oct. 1, 2015

Related U.S. Application Data
(60) Provisional application No. 62/100,606, filed on Jan. 7, 2015.

(51) Int. Cl. B65D 23/06; B60N 3/10; A47G 23/02

(52) U.S. Cl. CPC B65D 23/065; A47G 23/0216; B60N 3/103

(57) ABSTRACT

A cupholder device for absorbing moisture and spilled liquid so as to allow the exterior of the beverage container to remain dry. The cupholder device includes a base, upstanding sidewalls, and an open upper end, defining an interior volume in which the lower end of a beverage container can be positioned. The upper end of the cupholder device includes an elastic band that fits snugly against the exterior of a beverage container of any diameter. The cupholder device is composed of multiple layers, and preferably includes an interior layer composed of a porous material, an absorbent layer composed of an absorbent material, and an exterior layer composed of a waterproof layer. In this way, moisture or liquid that collects on the exterior of the cup passes through the porous layer and is absorbed in the absorbent layer.

### CROSS REFERENCE TO RELATED APPLICATION

This application claims the benefit of U.S. Provisional Application No. 62/100,606 filed on Jan. 7, 2015. The above identified patent application is herein incorporated by reference in its entirety to provide continuity of disclosure.

### BACKGROUND OF THE INVENTION

### Field of the Invention

The present invention relates to cupholders. More specifically, the present invention provides a liquid absorbing cupholder adapted to absorb moisture and spilled liquid in order to allow the exterior of a beverage container to remain dry. The cupholder comprises a base, upstanding sidewalls, and an open upper end defining an interior volume in which the lower end of a beverage container can be positioned. The upper end includes an elastic band for securing the cupholder to the walls of a beverage container. Further, the cupholder comprises a multi-layer construction, wherein the cupholder preferably includes at least an interior layer composed of a porous material, and an absorbent layer composed of an absorbent material.

Beverage containers, in which cold beverages are stored, often collect condensation or moisture on the exterior thereof. As a result, the exterior of the cup can become wet or damp. If the exterior of the beverage container is wet or damp, the user's hand may become wet when grasping the beverage container, which is undesirable. Further, the liquid on the beverage container may drip on the user while the user is taking a sip from the beverage container due to the built up condensation. If the beverage container is composed of paper or a similar material, the beverage container may begin to weaken and crumble if exposed to liquid for an extended period of time.

When a beverage container is stored in a vehicle's cupholders, the moisture or spilled liquid may pool in the vehicle cupholder. As a result, the vehicle cupholder may become wet and sticky, creating a mess that the user must clean at a later time. Further, the user may be unable to clean the cupholder until the user is finished driving, forcing the user to leave his or her beverage in the pooled liquid within the vehicle cupholder. Thus, a cupholder for a beverage container that is adapted to absorb liquid and condensation is desired.

Devices have been disclosed in the prior art that relate to coasters and cupholding devices. These include devices that have been patented and published in patent application publications. These devices generally relate to coasters having an absorbent layer or construction, such as U.S. Pat. No. 7,264,134, U.S. Design Pat. No. D261,592, U.S. Pat. No. 2,833,437, U.S. Pat. No. 4,978,566, U.S. Pat. No. 1,971,337, and U.S. Pat. No. 8,328,152.

These prior art devices have several known drawbacks. The devices in the prior art relate only to coasters on which the base of a beverage container can be placed, and do not disclose a cupholder that encloses or envelops the lower end of a beverage container. Thus, the coasters in the prior art do not help to remove moisture or liquid from the sidewalls of the beverage container. Further, the coasters are not adapted to remain connected to the beverage container when the container is lifted in order for the user to take a sip, and as a result liquid on the sides of the beverage container may drip onto the user as he or she drinks from the beverage container.

In light of the devices disclosed in the prior art, it is submitted that the present invention substantially diverges in design elements from the prior art and consequently it is clear that there is a need in the art for an improvement to existing liquid absorbing cupholder devices. In this regard the instant invention substantially fulfills these needs.

### SUMMARY OF THE INVENTION

In view of the foregoing disadvantages inherent in the known types of cupholders now present in the prior art, the present invention provides a new liquid absorbing cupholder wherein the same can be utilized for providing convenience for the user when removing moisture or liquid from the exterior of a beverage container.

It is therefore an object of the present invention to provide a new and improved liquid absorbing cupholder comprising a base, sidewalls, and an open upper end defining an interior volume in which a lower end of a beverage container can be positioned.

It is another object of the present invention to provide a liquid absorbing cupholder having an elastic band on the upper end thereof that allows the cupholder to fit snugly onto a beverage container.

Another object of the present invention is to provide a liquid absorbing cupholder having a multi-layer construction, wherein an interior layer is composed of a porous material, an absorbent layer is composed of an absorbent material, and an exterior layer is composed of a waterproof material.

Yet another object of the present invention is to provide a liquid absorbing cupholder that removes liquid or moisture from the base and sidewalls of a beverage container.

Another object of the present invention is to provide a liquid absorbing cupholder that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the liquid absorbing cupholder.

FIG. 2 shows a perspective view of an embodiment of the liquid absorbing cupholder in use.

FIG. 3 shows a side cross sectional view of an embodiment of the liquid absorbing cupholder.

### DETAILED DESCRIPTION OF THE INVENTION

Reference is made herein to the attached drawings. Like reference numerals are used throughout the drawings to depict like or similar elements of the liquid absorbing cupholder. For the purposes of presenting a brief and clear description of the present invention, the preferred embodiment will be discussed as used for removing moisture or liquid from the exterior of a beverage container. The figures are intended for representative purposes only and should not be considered to be limiting in any respect.

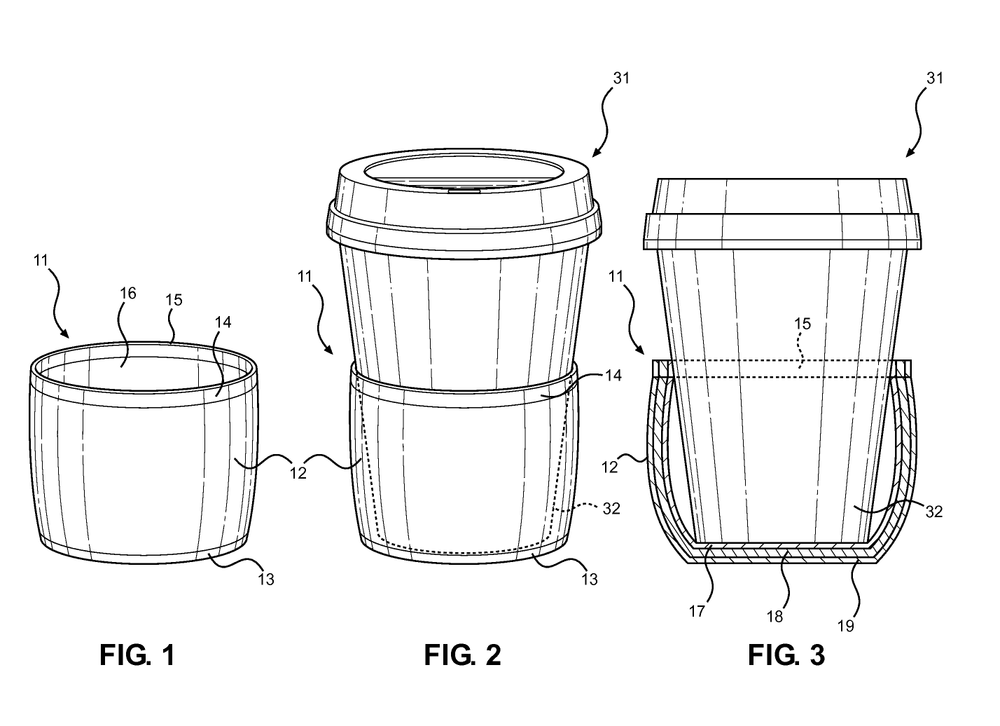

Referring now to FIGS. 1 and 2, there are shown perspective views of an embodiment of the liquid absorbing cupholder. The liquid absorbing cupholder 11 comprises a base 13, upstanding sidewalls 12, and an open upper end 14 defining an interior volume 16 in which the lower end 32 of a beverage container 31 can be positioned. The liquid absorbing cupholder 11 is adapted to enclose or envelop the base and lower end 32 of a beverage container 31 so as to collect moisture from the sidewalls and base of the beverage container 31.

The upper end 14 of the liquid absorbing cupholder 11 includes an elastic band 15 therearound. The elastic band 15 allows the liquid absorbing cupholder 11 to be applied to beverage containers of various sizes. Further, the elastic band 15 helps to secure the cupholder 11 to the beverage container 31 so that when the user moves the beverage container 31, the cupholder 11 remains secured to the container 31. In this way, the cupholder 11 remains on the container 31 while the user is drinking therefrom, helping to prevent the moisture on the container 31 from dripping onto the user.

The liquid absorbing cupholder 11 preferably comprises a circular cross section so as to be shaped similarly to cylindrical shaped bottles and cups. The base 13 is preferably substantially flat or planar so that it can rest flush against a surface and so that the lower end of a beverage container 31 can rest thereon. The base 13 may include a semi-rigid or rigid material so that the base 13 maintains its shape during use. The sidewalls 12 of the cupholder 11 are preferably flexible so that the sidewalls 12 can adjust to beverage containers 31 of various sizes.

Referring now to FIG. 3, there is shown a side cross sectional view of an embodiment of the liquid absorbing cupholder. The cupholder 11 comprises a multi-layer construction adapted to wick moisture away from the exterior of the beverage container 31 so that the exterior of the beverage container 31 remains dry. The cupholder 11 preferably comprises an interior layer 17 composed of a porous material that allows moisture and liquid on the exterior of the beverage container 31 to pass therethrough. The interior layer 17 is adapted to contact the base and/or sidewalls of the beverage container.

The cupholder 11 further includes an absorbent layer 18 composed of an absorbent material. Once the liquid passes through the porous interior layer 17, the liquid is absorbed by the absorbent layer 18. The absorbent layer 18 is preferably composed of a foam or sponge-like material adapted to collect and hold the liquid therein so that the liquid does not escape the absorbent layer 18. The absorbent layer 18 is coextensive with the interior layer 17 and can be secured thereto via any suitable fastening means, such as adhesives, heat sealing, among other fastening methods.

The cupholder 11 preferably comprises an exterior layer 19 composed of a waterproof material, such as a polymeric material. In this way, liquid collected by the absorbent layer 18 cannot escape the cupholder 11. The exterior layer 19 prevents liquid collected by the cupholder 11 to penetrate therethrough. In this way, the exterior of the cupholder 11 remains dry. The exterior layer 19 is coextensive with the absorbent layer 18 and is secured thereto via any suitable fastening means, such as by use of adhesives, heat sealing, or other suitable fastening methods.

In operation, the user can insert the lower end 32 of a beverage container 31 into the open upper end of the cupholder 11 such that the base of the beverage container 31 contacts the base of the cupholder 11. The elastic band 15 on the open upper end fits snugly around the exterior sidewall of the beverage container 31 so that the cupholder 11 remains secured to the beverage container 31. The beverage container 31 is in contact with the interior layer 17 of the cupholder 11 and moisture on the beverage container 31 can pass through the interior layer 17 into the absorbent layer 18. Liquid absorbed by the absorbent layer 18 is prevented from escaping therefrom via the waterproof exterior layer 19.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A liquid absorbing cupholder, comprising:
a cupholder having a base, sidewalls, and an open upper end defining an interior volume adapted to receive a lower end of a beverage container therein;
wherein said open upper end is removably securable to an exterior of said beverage container;
wherein said cupholder comprises an interior layer and an absorbent layer;
wherein said interior layer is adapted to contact said beverage container within said interior volume;
wherein said absorbent layer is composed of an absorbent material and is coextensive with said interior layer.

2) The liquid absorbing cupholder of claim 1, further comprising an exterior layer composed of a waterproof material, wherein said exterior layer is coextensive with said absorbent layer.

3) The liquid absorbing cupholder of claim 1, wherein said base is substantially flat.

4) The liquid absorbing cupholder of claim 1, wherein said open upper is removably securable to said beverage container via an elastic band disposed around said open upper end.

5) The liquid absorbing cupholder of claim 1, wherein said absorbent layer is composed of sponge.

6) The liquid absorbing cupholder of claim 1, wherein said cupholder comprises a circular cross section.

7) The liquid absorbing cupholder of claim 1, wherein said interior layer and said absorbent layer are secured to one another via adhesives.

8) The liquid absorbing cupholder of claim 1, wherein said absorbent layer is sandwiched between said interior layer and said exterior layer.
